(19) United States
(12) Patent Application Publication
(10) Pub. No.: US 2007/0246301 A1
(43) Pub. Date: Oct. 25, 2007

(54) Ladder leveling apparatus for adapting a ladder to an uneven surface

(76) Inventor: Wayne Alan Shaffer, Farmington, NY (US)

Correspondence Address: Galasso & Associates, LP, P.O. Box 26503, Austin, TX, 78755-0503, US

(21) Appl. No.: 11/408,350

(22) Filed: Apr. 21, 2006

(51) Int. Cl. E06C 7/00

(52) U.S. Cl. 182/201

(57) ABSTRACT

A ladder leveling apparatus is provided which is designed for easy installation onto and removal from a ladder, which may be installed to only one leg of a ladder rather than two legs, which is light in weight, which is easily adjustable by the end user, an apparatus which does not require the ladder to be adapted to the leveling apparatus through the use of holes and bolts, a ladder leveling device that adapts to a wide variety of ladders having a variety of leg sizes, a ladder leveling device that is applicable even for use for leveling with a step ladder.

### FIELD OF THE DISCLOSURE

The disclosures made herein relate generally to an apparatus for use with a ladder, and more particularly to novel apparatus that is removably installed on the legs of a ladder as to adapt the ladder to a sloped surface, thereby permitting the ladder to rest in a level alignment and reduce the chance of injuries due to ladder tipping and falls.

### BACKGROUND

Ladders are well known and are commonly used in a wide variety of commercial and personal tasks including home improvement, construction, and other uses whenever it is desired to climb to a height to perform work or to reach an elevated object placed out of human reach. Early forms of ladders were often constructed of wood members having two elongated leg members with cross rails or steps spaced at regular intervals up the legs and attached there between. Over years of use and development ladder materials have evolved beyond traditional wood construction into the use of aluminum and more recently fiberglass, all in a trend to yield a lighter weight ladder, one which is easier to transport and to move around and position for use.

Ladders are commonly seen and available in two major forms, step ladders and extension ladders. By extension ladders herein, we include single section ladders. Step ladders have a folding ‘A’ shaped configuration having four legs and are by design self supporting when placed on flat level surfaces. Extension ladders on the other hand have two parallel legs with a plurality of rungs there-between. Extension ladders can be single section, but are frequently two or three section ladders, the sections being individually moveable two legged ladder sections that are mounted in a parallel fashion to the back of the first or subsequent section. Multiple section extension ladders can be extended by positionally sliding the sections relative to each other until a composite extension ladder with the desired height or reach is obtained. After use, the extension ladder can be collapsed by sliding the sections together to reduce the size for transport. All of the above is old and well known in the art, but presented herein as background on the field to which the inventive disclosure pertains.

Unlike step ladders, extension ladders are not self supporting but instead must rest the upper portion of the ladder against another supportive surface such as the wall of a building or a tree branch or other supportive stationary object. While extension ladders have demonstrated by years of use over time to be essential tools, they have certain limitations due to their design. Extension ladders, once extended to reach a relatively long distance above the floor or resting surface are relatively unstable, this instability increasing dramatically with the total extended height of the extended sections. This can be understood as the ladder has two legs that are relatively close together in a fixed distance relationship, the leg distance being small particularly in relation to the height of the ladder extension. Placing a mass on the ladder in some position up on the ladder, the mass for example being a workman, makes the ladder prone to toppling over, resulting in bodily injury. Of key importance to the discussion herein, the instability of the ladder at a given extension height is greatly aggravated or degraded when the ladder is not positionally maintained in a vertical relationship along the plane of the leaning rest surface, say for example when the surface upon which the ladder base rests is uneven or sloped from left to right. This ideal alignment of the ladder is referred to as leveling the ladder, which can be understood as placing the ladder rungs in a level or true horizontal position such that the ladder rungs are substantially perpendicular to the vector force of gravity. By analysis, the vertical center of gravity of the ladder and worker plus materials supported thereby must lie vertically between the two legs of the ladder such that weight is shared in some proportion between the two legs. If the unevenness of the surface upon which the ladder rests tilts the ladder to one side such that this vertical center of gravity no longer lies between the ladder legs when projected vertically to the support surface, then laws of Physics or a simple review of a Statics text will show the ladder will tend to tip. Of course injury is likely to occur if it does. It is important to appreciate that the longer or higher the ladder is in its extension, the less tolerant it is in any misalignment from a true level resting placement upon the ladder base support surface, which is to say the longer the ladder extension, the less tolerant of being out of level before the ladder tips.

To level a ladder, a workman may use a block of wood, brick or other material to try to compensate for unevenness or slope in the floor upon which the ladder rests, thereby hoping to achieve a vertically leveled ladder placement that is least susceptible to tipping. Blocks and bricks are not adjustable objects, and so the degree of ladder ‘levelness’ is compromised, the safety of those using the ladder and around the ladder is impaired. Additionally, placing objects under the legs of a ladder does not make the ladder inherently stable, even more particularly if the items placed under the leg are stacked so as to achieve a degree of leveling. Such items, not being attached to the ladder leg, may slide from beneath the ladder leg resulting in a likely fall and injury.

As can be understood, the leveling problem and tipping problem is aggravated to the extreme when a ladder is resting upon a substantially sloped surface, such as when placed upon a building roof to reach a higher roof, or perhaps when placed on a sloped graded section of a yard adjacent to a building wall.

Over time various apparatus and devices have been disclosed for use in leveling a ladder. This problem has been long recognized and is well known. Many of these devices require that holes be drilled and bolts be applied to fasten the device to the ladder, while other apparatus are bulky providing two adjustable legs per ladder when a sloped surface requires the use of only a single adjustable leg, this extra adjustable component adding to the weight and inconvenient bulkiness of conventional ladder leveling apparatus. Additionally, conventional ladder leveling apparatus are not easily removed from and installed to a ladder, an example being the ones requiring holes and bolts through the ladder to adapt the ladder to the leveling apparatus. For these apparatus the ladders must be modified and adapted prior to their use when it would be desirable to have a ladder leveling device that can be directly applied and used with a wide variety of ladders without modifying or adapting the ladder before use.

Therefore, a ladder leveling apparatus which is designed for easy installation onto and removal from a ladder, which may be installed to only one leg of a ladder rather than two legs, which is light in weight, which is easily adjustable by the end user, an apparatus which does not require the ladder to be adapted to the leveling apparatus through the use of holes and bolts, a ladder leveling device that adapts to a wide variety of ladders having a variety of leg sizes, a ladder leveling device that is applicable even for use with step type ladders, such a ladder leveling apparatus would be useful and novel.

### SUMMARY OF THE DISCLOSURE

Accordingly, embodiments of the inventive disclosures made herein comprise various embodiments of a ladder leveling apparatus designed to be removably installed to one or more legs of ladders of various types, without modification or adaptation of the ladder to the leveling apparatus.

In one embodiment of the inventive disclosures made herein, a ladder leveling apparatus for adapting a ladder to a sloped surface comprises an elongated rectangular frame member or major housing component of the leveling apparatus. The frame member comprises a top end, a bottom end, a first surface in a facing relationship with the ladder leg, the first surface having a slot running between the bottom and the top ends of the frame member. The first surface is secured along opposing edges to the top and bottom ends of the frame member. A second surface is in an opposing relationship to the first surface, the second surface secured at opposing edges to the top and bottom ends, wherein the first and second surfaces have a width similar to the width of a ladder leg. The frame member having two opposing side surfaces, the side surfaces secured at opposing edges to the top and bottom ends of the frame member, the side surfaces secured along opposing major ends to the edges of the first and second surfaces. Secured to a top end of the frame member is a first bearing member having a hole there-through, the bearing member secured to the top end of the frame member. A second bearing member is provided having a bearing socket, the second bearing member secured to the bottom end of the frame member. A threaded rod is provided and positioned within the slot. The rod has a non-threaded top portion having a hole for receiving a pin therein, the top portion received in and extending through the hole in the first bearing member. The threaded rod having a non-threaded bottom portion received into and supportively resting in the bearing socket, wherein the threaded rod is permitted to rotate within the first and second bearing members. A crank handle is provided and connected to a top portion of the treaded rod in a fashion such that the crank handle is used to rotate the threaded rod. One or more elongated ‘U’ shaped guide straps are provided to encircle a leg of the ladder and thereby hold the ladder and leveling apparatus in a common axial alignment. The straps secured at their opposing ends to the opposing sides of the frame member, the straps together with the first surface of the frame member forming a closed sided guide that is sized to receive and guidably restrain a ladder leg against the frame member so as to maintain the ladder leg and leveling apparatus in alignment. To raise and lower the ladder leg a pocket member is provided. The pocket member has closed sides and a bottom with a rectangular top opening configured for receiving the ladder leg inside the pocket. The pocket configured to supporting the ladder leg by transferring the weight or force transmitted by the ladder leg to the leveling apparatus. A pocket height adjustment member is provided, the pocket height adjustment member having a threaded hole there-through to threadably and adjustably receive the threaded rod. The thread of the pocket height adjustment member is so sized and configured to threadably engage the threads of the threaded rod and thereby to positionally displace ladder leg receiving pocket up or down the rod as the rod is rotated, thereby changing the elevation of the ladder leg above the ladder support surface. The pocket height adjustment member is secured to a back wall of the pocket member, wherein the height of the pocket member is adjusted by rotation of the threaded rod by the crank handle.

Correspondingly, embodiments of the ladder leveling apparatus adapt one or more legs of the ladder to a level footing on an uneven or sloped surface. Embodiments are installable onto a variety of ladders without modifying either the ladder leveling apparatus or the ladder. In particular, the ladder legs do not need to have holes drilled nor bolts installed to mount the leveling apparatus as is the case with conventional ladder leveling apparatus. Additionally, ladder leveling apparatus in accordance with the inventive disclosures are suitable for use on a variety of uneven surfaces, such as for supporting a ladder on a sloped roof when the ladder is used to reach a higher roof from the first roof. Additionally, embodiments of the ladder leveling apparatus are installable onto both or just one leg of an extension ladder, if desired, rather than fitting both legs of an extension ladder with adjustable leveling as provided in the prior art. The ladder leveling apparatus according to the present inventive disclosure utilizes a threaded rod and a pocket height adjustment member which are threadably engaged by which the pocket height is raised and lowered by rotating the threaded rod by a crank. This leveling method results in an infinitely adjustable ladder leveling capability, as contrasted with leveling apparatus which rely upon bolts moved between a plurality of bolt holes to achieve a rough leveling adjustment which is only available in discrete steps.

Turning now to specific embodiments of the inventive disclosures made herein, in at least one embodiment of the inventive disclosures made herein, the pocket member into which the leg of the ladder is received comprises a ‘J’ shaped ladder leg support member having a back wall secured to the pocket height adjustment member which is raised and lowered by action of its threadable engagement with the threaded rod. In this embodiment the pocket cover comprises a three sided cover having a front wall secured along opposing edges to edges of two opposing side walls, a back edge of each three sided cover sidewall have a ‘U’ shaped channel formed thereon. The cover ‘U’ shaped channel is sized and adapted to engage upon and be slidably received upon the opposing side edges of the back wall of the ‘J’ shaped support member. The pocket cover thusly engaged is slidably removable from the ‘J’ shaped ladder leg support. This is useful when encountering a ladder with an unusually wide leg as removal of the cover permits a ladder with a larger leg to supportively rest upon the ‘J’ shaped support member, and therefore allows the leveling apparatus to be employed to level such a ladder.

In at least one embodiment of the inventive disclosures made herein, the crank handle of the ladder leveling device comprises a flat elongated coupling member having two holes, one hole through each of two opposing ends. The holes are sized and configured to receive a pin there-through. A handle member is provided having a hole on one end, the hole sized and configured to receive a pin there-through. A first pin fixes the handle member to a first end of the coupling member, wherein the handle member is free to rotate around the first pin. A second pin fixes the second end of the coupling member to the top portion of the threaded rod, wherein the coupling member is free to rotate about the second pin. This embodiment permits the crank handle to be folded or flipped from side to side about the rod as desired. This feature eliminates problems which can arise from the use of a longer crank handle that is long enough to collide with the ladder leg while being operated.

It is an objective of the inventive disclosure made herein to provide a ladder leveling apparatus that can be used with a variety of ladders.

It is an objective of the inventive disclosure made herein to provide a ladder leveling apparatus that can be attached to and used to level a ladder without drilling holes into the ladder or adapting the ladder in any way.

It is an objective of the inventive disclosure made herein to provide a ladder leveling apparatus that can be attached to only one leg of the ladder, namely the leg where additional height is required to level the ladder.

It is an objective of the inventive disclosure made herein to provide a ladder leveling apparatus that is infinitely adjustable.

It is an objective of the inventive disclosure made herein to provide a ladder leveling apparatus that can be used to level a step ladder on a sloped surface, for example by installing a leveling apparatus onto the right front and right rear legs of the step ladder, then the ladder can be leveled and used on a surface which slopes downwards to the right.

It is an objective of the inventive disclosure made herein to provide a ladder leveling apparatus that can be used with ladders having wider legs by providing a removable cover over the leg receiving pocket of the ladder leveling apparatus. In this case, the ladder leg rests upon the ‘J’ shaped ladder leg support of the ladder leveling apparatus, but the ladder leg is not dimensionally constrained to fit within the pocket wall dimensions as the pocket walls are removable.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 presents a perspective view of one embodiment of a ladder leveling apparatus in accordance with the inventive disclosures herein.

FIG. 2 presents a perspective view of one embodiment of a ladder leveling apparatus attached to the leg of a ladder and in use to level the ladder on a residential roof.

FIG. 3 presents a perspective view of one embodiment of a ladder leveling apparatus in accordance with the inventive disclosures herein, showing the threaded leveling rod and ladder pocket together with the crank handle and bearing members, illustrating the operation of the leveling apparatus

FIG. 4 presents a perspective view of an alternate embodiment of a ladder leveling apparatus in accordance with the inventive disclosures herein, wherein the ladder leg receiving and support pocket has a removable cover to accommodate a wider ladder leg.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

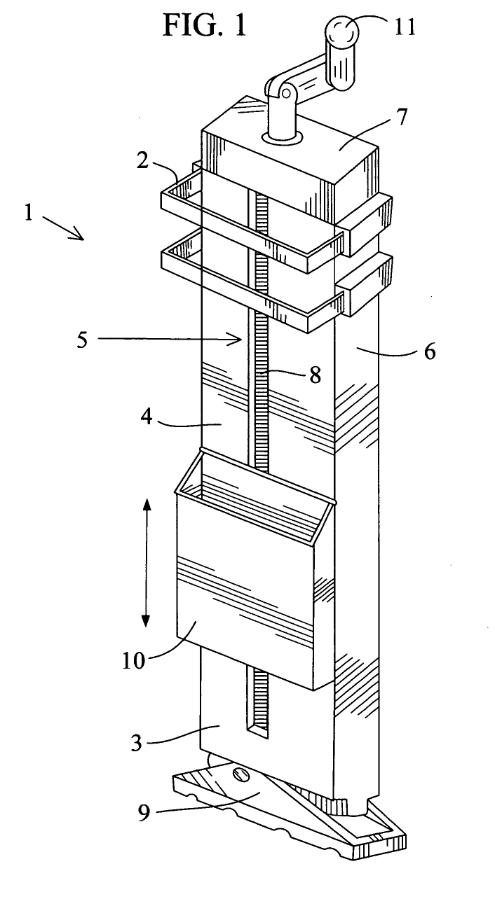

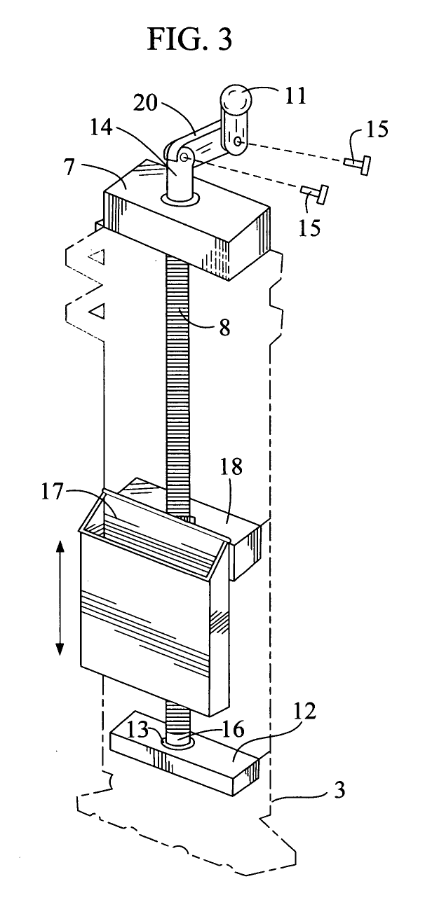

Turning now to FIG. 1 and FIG. 3:

FIG. 1 depicts a perspective view of an embodiment of a ladder leveling apparatus in accordance with an embodiment of the inventive disclosures made herein. FIG. 3 depicts a perspective view of one embodiment of a ladder leveling apparatus in accordance with the inventive disclosures herein in which the frame member 1 and swivel foot 9 are shown in dashed outline to better illustrate the threaded leveling rod 8 and ladder pocket 10 together with the crank handle 11 and bearing members 7 and 12, illustrating the operation of the leveling apparatus.

The ladder leveling apparatus includes an elongated rectangular frame member 1 comprising a top end 2, a bottom end 3, a first surface facing the ladder 4, the first surface having a slot 5 running between the bottom end and the top end. The first surface is secured at opposing edges to the top and bottom ends of the frame member 1. The first surface, which faces the ladder leg when in use, has a width similar to the typical width of a ladder leg. The frame member 1 having two opposing side surfaces 6 of which one is depicted, the side surfaces secured at opposing edges to the top 2 and bottom 3 ends of the frame member. A first bearing member 7 has a hole there-through for receiving a threaded rod 8. The first bearing member is secured to the top end of the frame member. A second bearing member 12 having a bearing socket 13, the second bearing member secured to the bottom end 3 of the frame member 1. A threaded leveling rod 8 is positioned within the slot 5. The leveling rod having a non-threaded top portion 14 received into and extending through the hole in the top bearing member 7, a top portion of the rod 14 extending beyond and outside the frame member 1 and has a hole through the top portion 14 of the rod to receive a pin 15. The threaded leveling rod 8 includes a non-threaded bottom portion 16 received into and supportively resting in the bearing socket 13, wherein the threaded rod 7 is permitted to rotate within the first and second bearing members 7 and 12. A ladder leg receiving pocket member 10 having closed sides and a bottom with a rectangular top opening 17 for receiving, supporting and leveling a ladder leg inside. The ladder leg receiving pocket is secured to a pocket height adjustment member 18 having a threaded hole there-through, the threaded hole threadably and adjustably receiving the threaded rod 8 there-through. The threads of the pocket height adjustment member are sized and configured to threadably engage the threads of the threaded rod wherein the height of the ladder leg receiving pocket member is adjusted vertically by rotation of the threaded rod 8 by the crank handle 11. The ladder leveling apparatus includes one or more elongated ‘U’ shaped ladder leg guide straps 19. The straps secured at their opposing ends to the sides 6 of the frame member 1, The guide straps together with the first surface 4 of the frame member 1 forming a closed sided guide to receive and guidably restrain a ladder leg against the frame member so as to maintain the ladder leg and leveling apparatus in alignment during use.

Embodiments of the ladder leveling apparatus can use a variety of leveling rod rotation means to rotate the leveling rod and adjust the ladder leg height. As above, the means can be a fixed crank handle secured to the end of the top end 14 of the leveling rod 8, or for example, the rotation means can include a hexagonal end formed onto the top end 14 of the threaded leveling rod, wherein the leveling rod is rotated by means of a standard socket set or open end wrench. In a preferred embodiment the leveling rod rotation means comprises a folding crank handle as pictured in FIG. 1 and FIG. 3, as discussed in further detail below.

The embodiment of the ladder leveling apparatus of FIG. 1 and FIG. 3 utilizes a folding crank handle. A flat elongated coupling member 20 has a hole through each of the opposing ends. The holes are sized and configured to receive pins 15 there-through. The crank handle 11 has a hole on one end that is sized and configured to receive a pin 15 there-through and thereby be secured to coupling member 20 while free to rotate around the pin. A second pin 15 fixes the free end of the coupling member to the top portion 14 of the threaded rod 8, wherein the coupling member 20 is free to rotate about the second pin, wherein the pin connections permit the handle to be folded or flipped from side to side about the rod as desired.

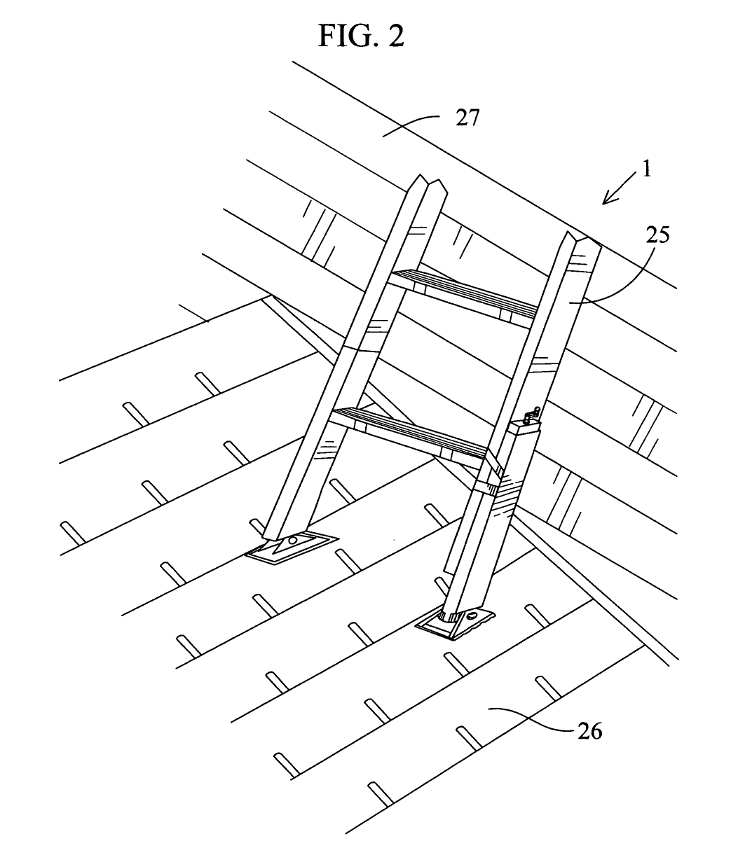

Turning now to FIG. 2. FIG. 2 depicts a perspective view of one embodiment of a ladder leveling apparatus attached to the leg of a ladder and in use to level the ladder resting upon a residential roof. The ladder leveling device 1 is removably mounted to a leg 25 of the ladder. The ladder leveling device has been adjusted to elevate the ladder leg 25 above the sloping roof surface 26 so as to compensate for the slope of the roof and put the ladder in a side to side vertical leaning relationship in resting against wall 27.

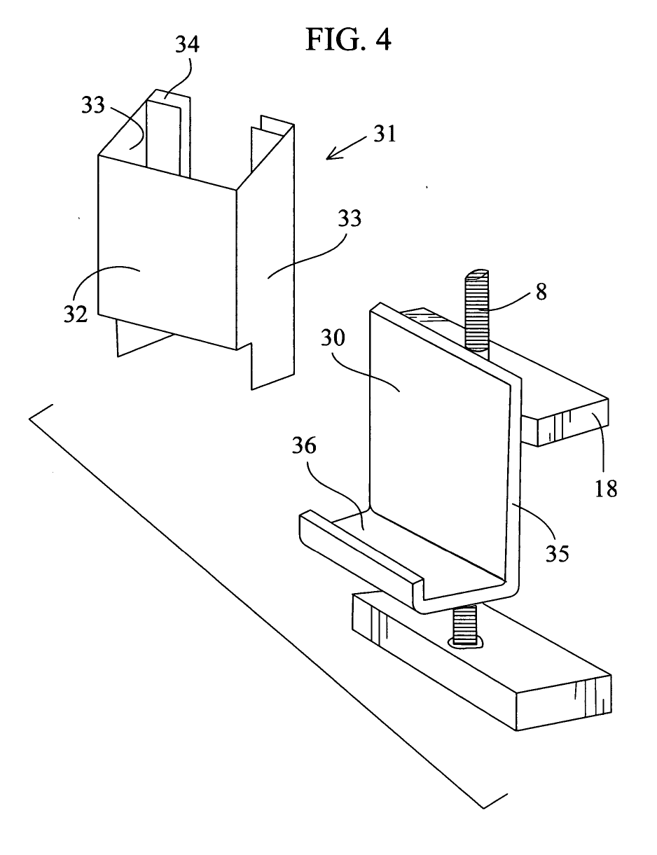

FIG. 4 depicts an alternate embodiment of the ladder leg receiving pocket identified as 10 in FIG. 1. The ladder leg receiving pocket comprises a ‘J’ shaped ladder leg support member 30 which is secured to the pocket height adjustment member 18.

The ladder leg receiving pocket has a removable three sided cover 31, the cover having a front wall 32 secured along opposing edges to edges of two opposing side walls 33. Each side wall 33 having a back edge onto which a ‘U’ shaped channel 34 is formed. The ‘U’ shaped channel 34 is sized and adapted to engage upon and be slidably received upon the opposing side edges 35 of the back wall of the ‘J’ shaped support member 30, wherein the cover 31 is slidably removable from the ‘J’ shaped ladder leg support 30 when desired, for example in the special case of a wider leg ladder. Removal of the cover permits the ladder leveling apparatus to be used with a ladder having a wider ladder leg. The ladder leg supportively rests within the channel shaped bottom 36 of the ‘J’ shaped support member 30.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A ladder leveling apparatus for adapting a ladder to an uneven surface, the ladder leveling apparatus comprising:
an elongated rectangular frame member comprising:
a top end;
a bottom end;
a first surface facing the ladder, the first surface having a slot running between said bottom and said top end, the first surface secured at opposing edges to the top and bottom ends;
a second surface opposing the first surface, the second surface secured at opposing edges to the top and bottom ends, wherein the first and second surfaces have a width similar to width of a ladder leg; and
two opposing side surfaces, the side surfaces secured at opposing edges to the top and bottom ends, the side surfaces secured along opposing major ends to edges of the first and second surfaces;
a first bearing member having a hole there-through, the bearing member secured to the top end of the frame member;
a second bearing member having a bearing socket, the second bearing member secured to the bottom end of the frame member;
a threaded leveling rod positioned within the slot, the rod having a non-threaded top portion having a hole for receiving a pin therein, the top portion received in and extending through the hole in the first bearing member, the rod having a non-threaded bottom portion received into and supportively resting in the bearing socket, wherein the threaded rod is permitted to rotate within the first and second bearing members;
a leveling rod rotation means connected to a top portion of the threaded rod, wherein the rotation means is used to rotate the treaded rod and thereby adjust height of the ladder leg;
one or more elongated ‘U’ shaped guide straps, the straps secured at their opposing ends to the opposing sides of the frame member, the straps together with the first surface of the frame member forming a closed sided guide, the guide sized to receive and guidably restrain a ladder leg against the frame member so as to maintain the ladder leg and leveling apparatus in axial alignment;
a pocket member having closed sides and a bottom with a rectangular top opening for receiving, supporting and leveling the ladder leg inside, the pocket member configured to supportively transfer the weight or downwards force on the ladder leg to the leveling apparatus; and
a pocket height adjustment member having a threaded hole there-through, the threaded hole threadably and adjustably receiving the threaded rod there-through, the thread of the pocket height adjustment member sized and configured threadably engage the threads of the threaded rod, the pocket height adjustment member secured to a back wall of the pocket member, wherein the height of the pocket member is adjusted by rotation of the threaded rod by the crank handle.

2. The ladder leveling apparatus of claim 1, wherein the leveling rod rotation means comprises a fixed crank handle secured to the end of the top portion of the threaded leveling rod.

3. The ladder leveling apparatus of claim 1, wherein the leveling rod rotation means comprises a hexagonal drive end formed onto the top portion of the threaded leveling rod, wherein the leveling rod is rotated by means of a standard socket set or open end wrench removably fitted to the hexagonal drive end.

4. The ladder leveling apparatus of claim 1, wherein the pocket member comprises:
a ‘J’ shaped ladder leg support member wherein the back wall secured to the pocket height adjustment member is back wall of the ‘J’ shaped support member; and
a three sided cover having a front wall secured along opposing edges to edges of two opposing side walls, a back edge of each three sided cover sidewall have a ‘U’ shaped channel formed thereon, the ‘U’ shaped channel sized and adapted to engage upon and be slidably received upon opposing side edges of the back wall of the ‘J’ shaped support member, wherein the cover is slidably removable from the ‘J’ shaped ladder leg support in special case of a wider leg ladder, thereby permitting a ladder with a larger leg to supportively rest upon the ‘J’ shaped support member.

5. The ladder leveling apparatus of claim 4, wherein the leveling rod rotation means comprises:
a flat elongated coupling member having two holes, one through each of two opposing ends, the holes sized and configured to receive a pin there-through;
a handle member having a hole on one end, the hole sized and configured to receive a pin there-through;
a first pin fixing the handle member to a first end of the coupling member, wherein the handle member is free to rotate around the first pin; and
a second pin fixing a second end of the coupling member to the top portion of the threaded rod, wherein the coupling member is free to rotate about the second pin, wherein the pin connections permit the handle to be folded or flipped from side to side about the rod as desired.

6. The ladder leveling apparatus of claim 1, wherein the ladder leveling apparatus comprises aluminum.

7. The ladder leveling apparatus of claim 6, wherein the ladder is an extension ladder and the ladder leveling apparatus is installed to only one leg of the ladder.

8. The ladder leveling apparatus of claim 6, wherein the ladder is a step ladder and the ladder leveling apparatus is installed to two legs of the ladder.
